(19) United States
(12) Patent Application Publication
(10) Pub. No.: US 2013/0049482 A1
(43) Pub. Date: Feb. 28, 2013

(54) SYSTEM AND METHOD FOR REGULATING INDUCTIVE POWER TRANSMISSION

(71) Applicants: Arik Rofe, Jerusalem (IL); Amir Ben-Shalom, Modiin (IL); Oola Greenwald, Mevasseret Zion (IL); Alfred Leibovitz, Petah Tikva (IL)

(72) Inventors: Arik Rofe, Jerusalem (IL); Amir Ben-Shalom, Modiin (IL); Oola Greenwald, Mevasseret Zion (IL); Alfred Leibovitz, Petah Tikva (IL)

(73) Assignee: Powermat Ltd., Neve Ilan (IL)

(21) Appl. No.: 13/499,920

(22) PCT Filed: Sep. 16, 2010
(86) PCT No.: PCT/IL10/00759

§ 371 Date: Aug. 7, 2012

Related U.S. Application Data
(60) Provisional application No. 61/246,327, filed on Sep. 28, 2009.
(60) Provisional application No. 61/262,276, filed on Nov. 18, 2009.
(60) Provisional application No. 61/360,629, filed on Jul. 1, 2010.

(51) Int. Cl. H01F 38/14

(52) U.S. Cl. 307/104

(57) ABSTRACT

An inductive power receiver provides a regulated power output to an electric load. The receiver inductively couples with an inductive power transmitter to form an inductive transfer system. A receiver-side regulator is provided to regulate the output voltage of the inductive transfer system. The regulator has a resonance-altering component and a switching unit configured to selectively connect the resonance-altering component to the reception circuit such that the amplitude of the induced voltage is controlled.

### FIELD OF THE INVENTION

The present invention relates to the regulation of power in contactless power transmission systems. More specifically, the invention relates to receiver-sidepower regulation of inductive power transmission systems.

### BACKGROUND

Inductive power transmission systems are a convenient power provision alternative to common plug and socket power connections. Inductive power transmission allows power to be transferred from an inductive power outlet to an inductive power receiver with no connecting wires.

An oscillating electrical potential, or driving voltage, is applied across a primary inductor associated with the inductive power outlet. This produces a varying magnetic field in the vicinity of the primary inductor. When the inductive receiver is brought near to the inductive outlet, a secondary potential difference, or output voltage, is generated across a secondary inductor positioned within this varying magnetic field. The output voltage may be used to charge or power electrical devices wired to the secondary inductor.

In order to maintain a stable operating voltage for an electrical device it is necessary to regulate the output voltage from the secondary inductor. Regulation of the output voltage may be provided by monitoring the output voltage, providing feedback signals from the receiver to the outlet and controlling the driving voltage accordingly. Such a system relies upon a communication channel for transmitting feedback signals between the receiver and the outlet. Although various communication systems have been suggested to provide wireless feedback, the signal channel generally demands additional components which may be bulky and inefficient.

Regulation systems may avoid the need for such a communication channel by the use of receiver-side regulating elements. Various receiver-side regulation elements may be used to stabilize the output voltage when the secondary voltage varies. Such elements include buck converters, LDOs and reverse biased Zener diodes wired in parallel to the load. It is noted, however, that these regulating elements typically include bulky components and thereby increase the minimum size of the inductive receiver.

Furthermore receiver-side regulating elements, such as those listed above, generally require the secondary voltage induced across the secondary inductor to be higher than the required output voltage. Consequently, such receiver-side regulation systems are inherently inefficient and typically generate significant heat within the power receiver.

There are a number of problems associated with the heat generated by known receiver-side regulation systems. Heat produces high temperatures which may reduce overall efficiency and may also reduce the reliability of components. Much design effort is typically required to overcome this problem, and other factors such as the dimensions of the system may be compromised as a result.

The need remains, therefore, for an energy efficient receiver-side regulation system for use with inductive power receivers. Embodiments described herein address this need.

### SUMMARY OF THE EMBODIMENTS

Embodiments of an inductive power receiver are presented herein having a reception circuit configured to inductively couple with an inductive power transmitter to form an inductive transfer system, the reception circuit comprising at least one secondary inductor configured to inductively couple with a primary inductor associated with the inductive power transmitter, and a regulator, configured to regulate an output voltage of the reception circuit, wherein the regulator comprises: at least one resonance-altering component, and at least one switching unit configured to selectively connect the resonance-altering component to the reception circuit.

Optionally, the inductive transfer system has a first resonant frequency and the inductive power transmitter generates a driving voltage across the primary inductor at a transmission frequency significantly different from the first resonant frequency. Typically, the transmission frequency is higher than the first resonant frequency. Alternatively, the transmission frequency is lower than the first resonant frequency.

Generally, when the resonance-altering component is connected to the reception circuit, the inductive transfer system has a second resonant frequency. Typically, the resonance-altering component is selected such that the transmission frequency is closer to the second resonant frequency than the first resonant frequency. Optionally, the resonance-altering component may be selected such that the second resonant frequency is higher than the first resonant frequency. Alternatively, the resonance-altering component may be selected such that the first resonant frequency is higher than the second resonant frequency.

According to various embodiments, the resonance-altering component comprises a capacitor. According to other embodiments, the resonance-altering component comprises an inductor. Optionally, the resonance-altering component comprises a capacitor selectively connectable in parallel to the secondary inductor.

Optionally, the switching unit comprises at least one power MOSFET. Typically, the switching unit is configured to connect the resonance-altering component when the output voltage is less than a threshold value.

Some embodiments of the inductive power receiver include a comparitator configured to compare the output voltage across with at least one reference value. Accordingly, the switching unit may be configured to connect the resonance-altering component to the receiver circuit when the output voltage is less than a first reference value. Typically, the switching unit is configured to disconnect the resonance-altering component from the receiver circuit when the output voltage is above the first reference value. Optionally, the regulator may be further configured to disconnect the secondary inductor from the receiver circuit when the output voltage is higher than a second reference value. Accordingly, the regulator is further configured to connect the secondary inductor to the receiver circuit when the output voltage is lower than the second reference value.

A method is taught for regulating output voltage from a reception circuit of an inductive power transfer system, the method comprising the steps: step (a)—driving a primary inductor at a transmission frequency different from a first resonant frequency of the inductive power transfer system; step (b)—inducing a secondary voltage across a secondary inductor associated with the reception circuit; step (c)—monitoring the output voltage from the reception circuit; step (d)—comparing the output voltage with a first reference value; and step (e)—if the output voltage is less than the first reference value, connecting a resonance-altering component to the reception circuit such that the resonant frequency of the inductive power transfer system shifts closer to the transmission frequency.

Variously, the method may further comprise at least one of the additional steps, step (f)—if the output voltage is above a second reference value, disconnecting the secondary inductor from the reception circuit, step (g)—disconnecting the resonance-altering component from the reception circuit when the output voltage equals the first reference value, and step (h)—reconnecting the secondary inductor from the reception circuit when the output voltage equals the second reference value.

According to other embodiments, an electrical device is presented incorporating the inductive power receiver. Variously, the electrical device may be selected from a group consisting of: telephones, media players, PDAs, Walkmans, portable music players, dictaphones, portable DVD players, mobile communications devices, standing lamps, video recorders, DVD players, paper shredders, fans, photocopiers, computers, printers, cooking appliances, fridges, freezers, washing machines, clothes dryers, heavy machinery, desk lamps, ambient lighting units, fans, wireless telephones, speakers, speaker phones, conference call base units, electric pencil sharpeners, electric staplers, display devices, electronic picture frames, VDUs, projectors, televisions, video players, music centers, calculators, scanners, fax machines, hot plates, electrically heated mugs, mobile phones, hairdryers, shavers, defoliators, delapidators, heaters, wax-melting equipment, hair curlers, beard trippers, bathroom-scales, lights and radios, egg beaters, bread-makers, liquidizers, citrus juice extractors, vegetable juicers, food-processors, electric knives, toasters, sandwich toasters, waffle makers, electrical barbecue grills, slow cookers, hot-plates, deep-fat fryers, electrical frying pans, knife sharpeners, domestic sterilizers, kettles, urns, radios, cassette players, CD players and electrical tin-openers, popcorn makers and magnetic stirrers and the like.

Another inductive power receiver is presented having a reception circuit configured to inductively couple with an inductive power transmitter to form an inductive transfer system, the reception circuit comprising at least one secondary inductor configured to inductively couple with a primary inductor associated with the inductive power transmitter; a regulator, configured to regulate an output voltage of the reception circuit; and a capacitance element connected across the terminals of secondary inductor such that current through the primary inductor has a smooth half-sinewave profile. Optionally, the regulator may comprise at least one step-down DC/DC converter. Additionally or alternatively, the regulator may comprise at least one O-ring diode.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion only, and are presented in the cause of providing what is believed to be the most useful and readily understood description of the principles and conceptual aspects of the embodiments. In this regard, no attempt is made to show structural details of the embodiments in more detail than is necessary for a fundamental understanding; the description taken with the drawings making apparent to those skilled in the art how the several forms of the invention may be embodied in practice. In the accompanying drawings:

FIGS. 1a and 1b show an inductive power transmitter and an inductive power receiver for use in an contactless power transmission system according to a first embodiment;

FIGS. 1c, 1d and 1e show three alternative inductive power adaptors according to other embodiments of the inductive power receiver;

FIGS. 2a and 2b are block diagrams showing the main components of two embodiments of inductive power transmission systems including a receiver-side regulator according to further embodiments;

FIG. 3 is a schematic block diagram of the main electrical components of the inductive power transmission system including a resonance-altering component which may be introduced into the power reception circuit according to an exemplary embodiment;

FIG. 4 is a graph showing how the output voltage of the secondary inductor of the exemplary embodiment varies with transmission frequency with and without the resonance-altering component connected;

FIG. 5 is a circuit diagram representing the transmitter and receiver circuits of an inductive power transfer system according to another embodiment;

FIG. 6 is a flowchart of a method for regulating inductive power transfer using a receiver based regulator according to still another embodiment;

FIG. 7 is a block diagram showing the main electrical components of a constant frequency inductive power transmission system including a receiver-side regulator, and

FIG. 8 is a model circuit diagram representing a further example of an inductive power transmission system including a receiver-side regulator.

### DETAILED DESCRIPTION OF SELECTED EMBODIMENTS

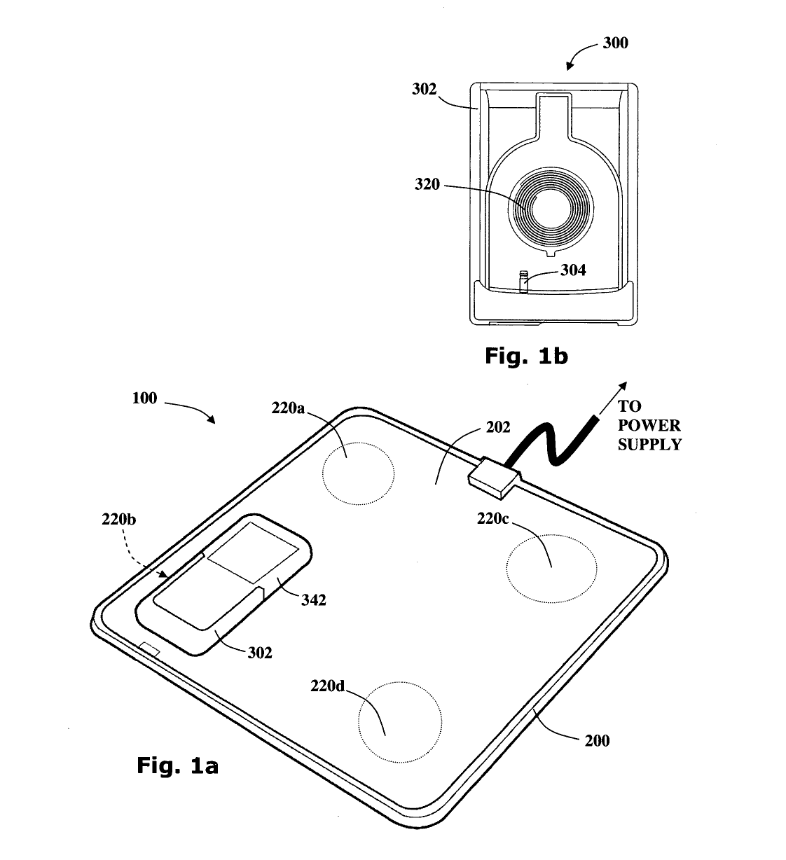

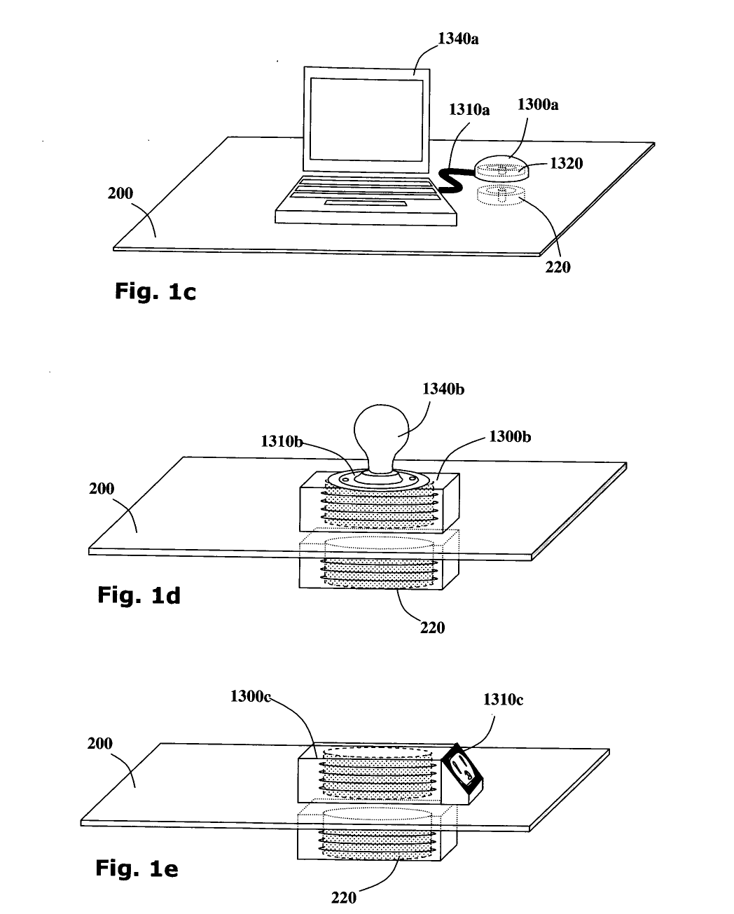

Reference is now made to FIGS. 1a and 1b showing an inductive power transmission system 100 according to a first embodiment. The transmission system 100 includes an inductive power outlet 200 and an inductive power receiver 300. The inductive power outlet 200 is configured to transmit power to the inductive power receiver 300 wirelessly using electromagnetic induction.

The inductive power outlet 200 of the first embodiment consists of four primary inductors 220a-d incorporated within a platform 202. The inductive power receiver 300 includes a secondary inductor 320 incorporated within a case 302 for accommodating a mobile telephone 342. When a mobile telephone 342 is placed within the case 302 a power connector 304 electrically connects the secondary inductor 320 with the mobile telephone 342. As shown in FIG. 1a, the inductive power receiver 300 may be placed upon the platform 202 in alignment with one of the primary inductors 220b so that the secondary inductor 320 inductively couples with the primary inductor 220b.

It is noted that in alternative embodiments, inductive power receivers may be otherwise configured, for example being incorporated within powerpacks for charging power cells or being wired directly to electrical loads for powering such loads directly. In still other embodiments of the inductive power receiver, dedicated inductive power adaptors are provided for connecting to electrical devices by power cables which may be hard wired to the adaptor or connectable via a conductive pin-and-socket connector.

FIGS. 1c, 1d and 1e show three alternative power adaptors 1300a-c according to embodiments of the inductive power receiver 300. FIG. 1c shows a first inductive power adaptor 1300a connected to a computer 1340a via a hardwired power cable 1310a. The first inductive power adaptor 1300a draws power from an inductive power transmitter 200 via a secondary inductor 1320. FIG. 1d shows a second inductive power adaptor 1300b hardwired to a light fitting 1310b for inductively powering a light bulb 1340b. FIG. 1e, shows still a third inductive power adaptor 1300c in which a conventional mains-type power socket 1310c is providing for connecting to external electrical device (not shown) via conventional power plugs.

It will be appreciated that various embodiments of the inductive power receiver may be used to provide power to a variety of electrical devices either via adaptors or through the inductive receiver directly into the electrical devices. Thus, for example, inductive receivers may be used to power entertainment equipment such as media players, portable music players, video recorders, DVD players, portable DVD players, radios, cassette players, Walkman®s, CD players, televisions, video players, music centers and the like.

In addition, inductive receivers may be used in the work environment to power office equipment such as computers, telephones, PDAs, dictaphones, mobile communications devices, standing lamps, paper shredders, fans, photocopiers, printers, desk lamps, wireless telephones, mobile telephones, speakers, speaker phones, conference call base units, electric pencil sharpeners, electric staplers, display devices, electronic picture frames, VDUs, projectors, calculators, scanners, fax machines as well as heavy machinery and the like.

Because no conductive connections are required, inductive power transfer is particularly suited for use in wet environments. Thus in some embodiments, inductive power receivers may be used to provide power to devices used in the kitchen such as the cooking appliances, fridges, freezers, washing machines, clothes dryers, ambient lighting units, fans, hot plates, electrically heated mugs, egg beaters, bread-makers, liquidizers, citrus juice extractors, vegetable juicers, food-processors, electric knives, toasters, sandwich toasters, waffle makers, electrical barbecue grills, slow cookers, hot-plates, deep-fat fryers, electrical frying pans, knife sharpeners, domestic sterilizers, kettles, urns, and electrical tin-openers, popcorn makers and magnetic stirrers and the like.

Inductive power receivers are similarly suitable for providing power to devices commonly used in the bathroom environment such as hairdryers, shavers, defoliators, delapidators, heaters, wax-melting equipment, hair curlers, beard trippers, bathroom-scales, lights and radios and such like.

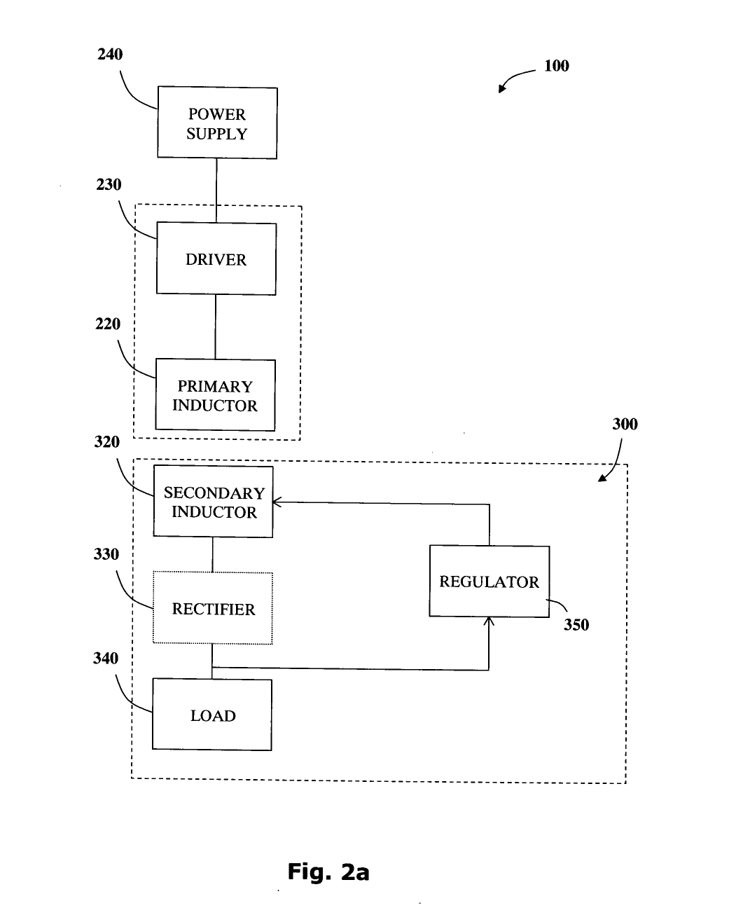

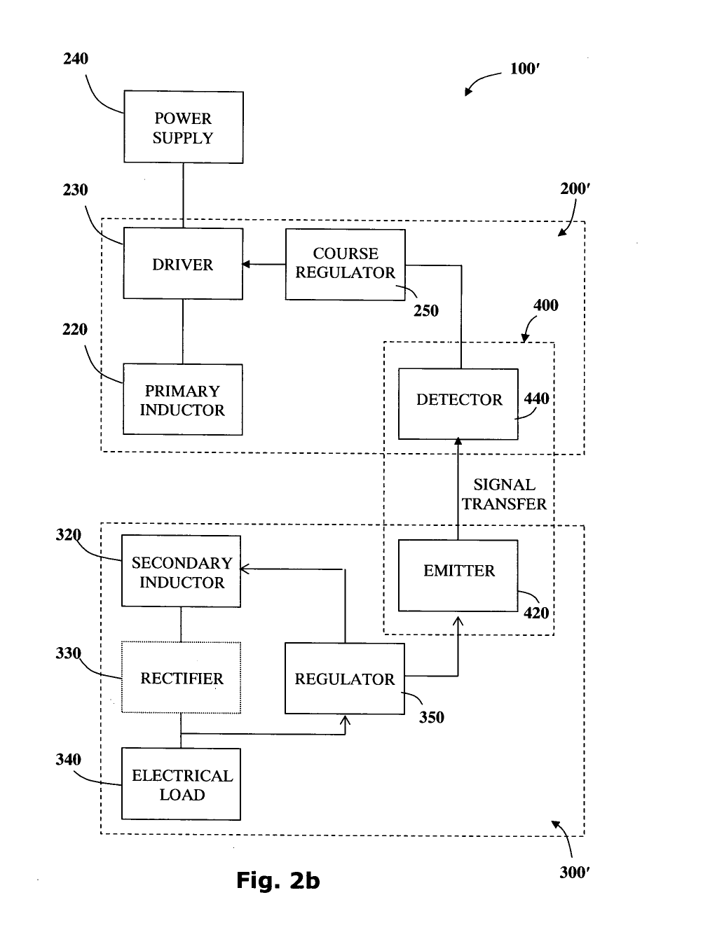

Referring now to FIG. 2a, a block diagram is shown representing the main components of such an inductive power transmission system 100. It is a particular feature that the regulation of power transfer is controlled, at least in part, by a regulator 350 in the inductive power receiver 300.

The inductive power outlet 200 includes a primary inductor 220, wired to a power supply 240 via a driver 230. The driver 230 typically includes electronic components, such as a switching unit, an inverter or the like, for providing an oscillating electrical potential to the primary inductor 220. The oscillating electrical potential across the primary inductor 220 produces an oscillating magnetic field in its vicinity.

The inductive power receiver 300 includes a secondary inductor 320 wired to an electric load 340, typically via a rectifier 330. The secondary inductor 320 is configured such that, when placed in the oscillating magnetic field of an active primary inductor 220, a secondary voltage is induced across the secondary inductor 320. The secondary voltage may be used to power the electric load 340. It is noted that an induced secondary voltage across the secondary inductor 320 produces an alternating current (AC). Where the electric load 340 requires direct current (DC), such as for charging electrochemical cells, the rectifier 330 is provided to convert AC to DC. Where AC output is required, such as in the inductive power adaptor 1300c (FIG. 1e) used for providing a mains-type output, an inverter, an AC-AC converter or the like (not shown)may be further provided.

The receiver-side regulator 350 is configured to directly monitor the output voltage produced by the secondary inductor 320 and to compare the monitored output value with the operating voltage required by the electric load 340. The regulator 350 is further configured to bring the monitored output voltage closer to the required operating voltage of the electric load 340 by adjusting the resonant frequency of the inductive transmission system 100. Optionally the regulator 350 may be further configured to monitor additional operating parameters, such as temperature, current and the like.

Referring now to FIG. 2b, in selected embodiments of the inductive power transfer system 100′, a signal transfer system 400 is provided for passing signals between the inductive power receiver 300′ and the inductive power outlet 200′. The signal transfer system 400 includes a signal emitter 420, associated with the inductive power receiver 300′ and a signal detector 440, associated with the inductive power outlet 200′. Various signal transfer systems may be used such as combinations of optical, inductive, ultrasonic signal emitters or the like and their associated detectors as well as coil-to-coil signal transmission systems, such as described in the applicant's co-pending United States patent applications, application numbers U.S. Ser. No. 12/497,088 and U.S. Ser. No. 12/563,544, incorporated herein by reference.

The receiver-side regulator 350 may utilize the signal transfer system 400 to communicate operating parameters to the inductive power transmitter 200′. A transmitter-side regulator 250 may be provided for receiving feedback signals from the signal detector 440 and to adjust the driving voltage to the primary inductor 220 accordingly. Typically the receiver-side regulator 350 may perform ongoing fine regulation without communicating any signals to the transmitter-side regulator 250 at all, with the transmitter-side regulator 250 being principally used for course adjustment.

Furthermore, the signal transfer system may additionally be used to communicate other signals for a variety of functions such as inter alia, confirming the presence of a power receiver 300′, communicating an identification signal or for communicating required power transmission parameters. The latter being particularly useful in systems adapted to work at multiple power levels.

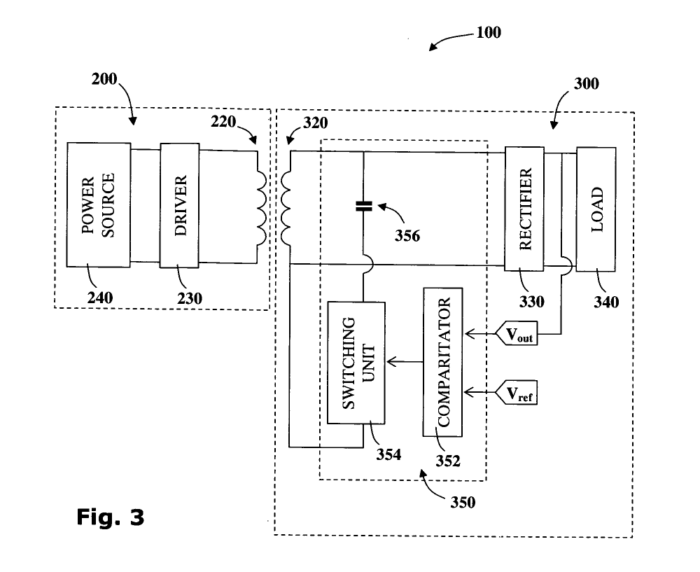

Reference is now made to FIG. 3 showing a schematic block diagram of the main electrical components of a power reception circuit of the inductive power transmission system 100 according to an exemplary embodiment. The inductive power transmission system 100 includes an inductive power transmitter 200 and an inductive power receiver 300. Power is transferred inductively from a primary inductor 220 associated with the inductive power transmitter 200 to a secondary inductor 320 associated with the inductive power receiver 300. The voltage induced in the secondary inductor 320 is rectified by a rectifier 330 producing an output voltage Vout which is provided to an electric load 340.

It is particularly noted that a receiver-side regulator 350 is provided to control the inductive power transmission. The receiver-side regulator 350 includes a comparitator 352, a switching unit 354 and a resonance-altering component 356. The comparitator 352 is configured to compare the monitored output voltage Vout with a reference voltage Vref having a value indicating the required operating voltage of the electrical load. The switching unit 354 is typically configured to connect the resonance-altering component 356 to the power reception circuit when the difference between the monitored output voltage Vout and the reference voltage Vref exceeds a threshold value.

The resonance-altering component 356 is selected such that when it is introduced into the power reception circuit the natural resonant frequency of the inductive power transfer system 100 is altered. One example of such a resonance-altering component 356 is a capacitor, which may be selectively connected to the reception circuit in parallel with the secondary inductor 220 to increase the natural resonant frequency of the inductive power transfer system 100. Other resonance altering components 356 (not shown) may include capacitors selectively connected in series with the secondary inductor 220 to reduce the natural resonant frequency, ancillary inductors connected to the secondary inductor 220 to increase the natural resonant frequency and the like. In certain embodiments a plurality of resonance-altering components 356 may be used in combination.

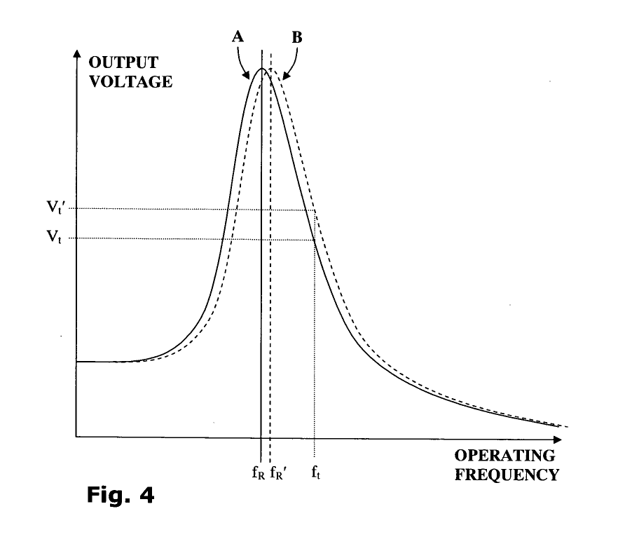

FIG. 4 is a graph showing how the output voltage of the secondary inductor of the exemplary embodiment varies with operating frequency. The output voltage peaks when the operating frequency is equal to the resonant frequency fR, fR′ of the system. The full line A represents the voltage profile for the reception circuit with no resonance-altering component connected. The dashed line B represents the voltage profile for the reception circuit with a resonance-altering component connected such that the resonant frequency of the system increases from fR to fR′. Such an increase may be effected, for example, by connecting a capacitor in parallel with the secondary inductor 320, as shown in FIG. 3.

In contradistinction to prior art systems which use resonant altering components to actively seek resonance, it is a particular feature of these embodiments that the transmission frequency ft is different from the resonant frequency fR of the system. It is noted that, for a transmission frequency ft above the resonant frequency fR of the system, the output voltage Vt may be increased by increasing the resonant frequency of the system. Thus, if a resonant increasing element, such as the parallel capacitor 356 (FIG. 3), is introduced into the reception circuit, an output voltage at a certain value Vt may rise to a higher value Vt′. A receiver-side regulator may therefore be configured to connect the resonant increasing element whenever the monitored output voltage Vout drops below the required operating voltage Vreq.

Further embodiments may include elements for reducing the output voltage Vout if it rises above the required operating voltage Vreq. Such voltage reducing elements may include resonance decreasing elements or alternatively switching units for intermittently disconnecting the load from output voltage altogether.

Embodiments described hereinabove relate to inductive power transmission systems which operate at a transmission frequency fR higher than the resonant frequency ft of the system. It will be appreciated that other embodiments may operate at transmission frequencies lower than the resonant frequency ft of the system. Where the operating frequency is lower than the resonant frequency fR, the regulator may be configured to introduce resonance reducing elements into the reception circuit in order to increase the output voltage and introduce resonance increasing elements into the reception circuit in order to reduce the output voltage.

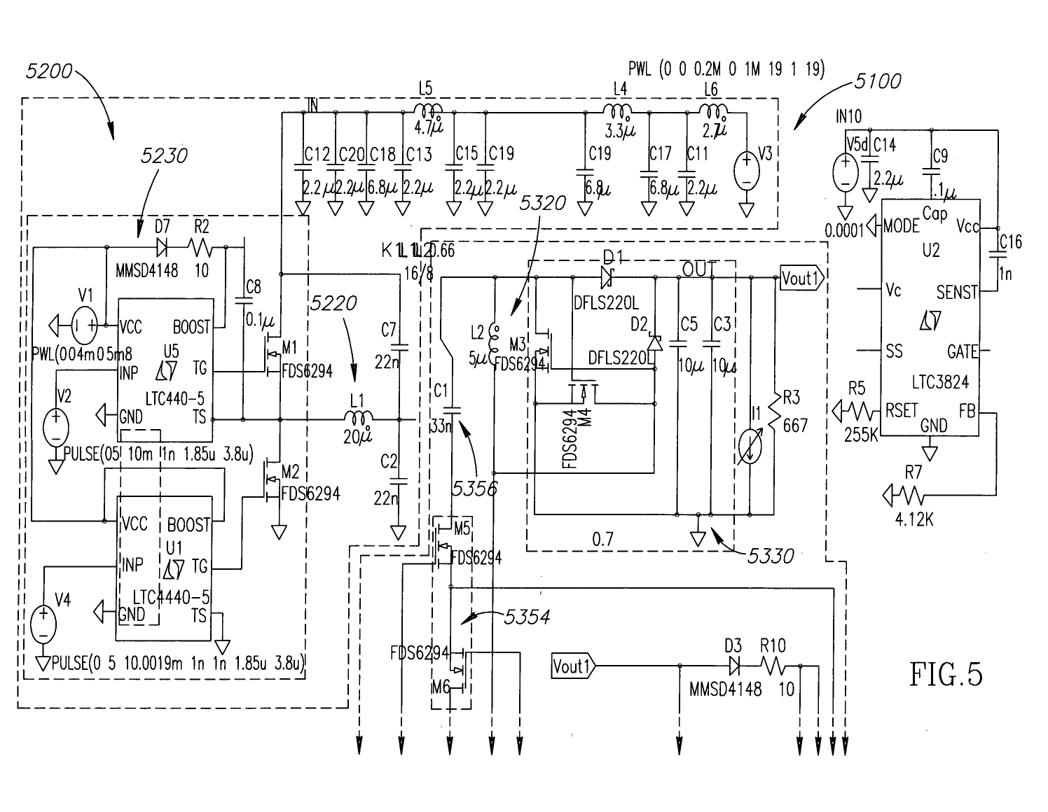

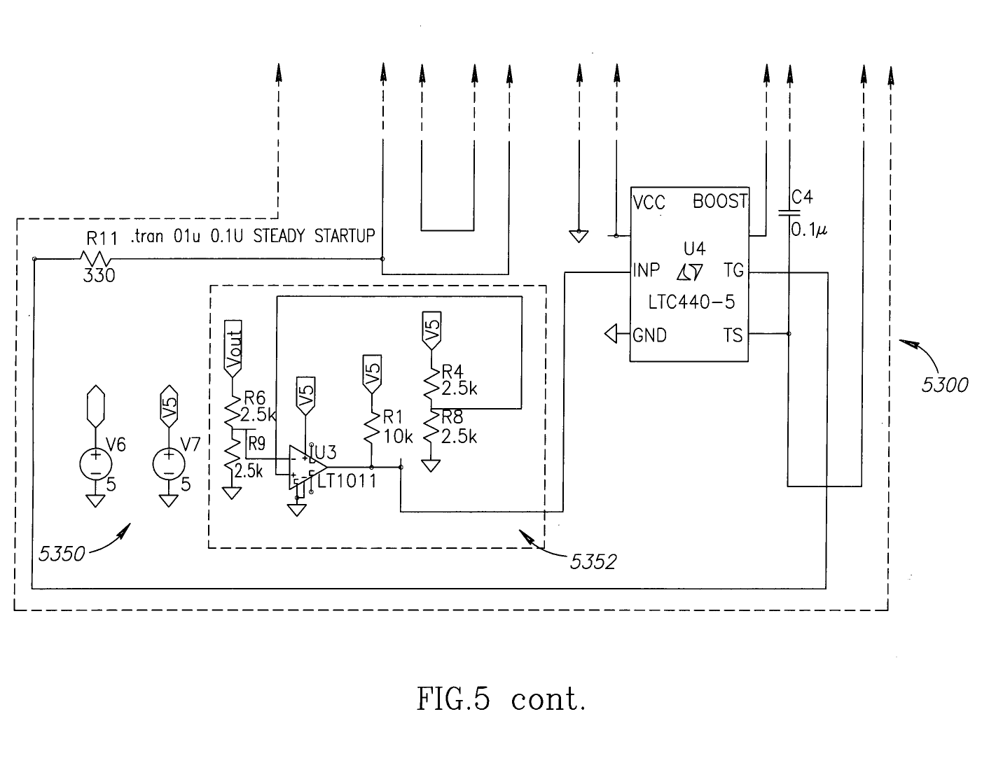

Reference is now made to FIG. 5 showing a possible circuit diagram of an inductive power transfer system 5100 according to a basic embodiment of the present invention. The inductive power transfer system 5100 includes an inductive transmitter 5200 and an inductive receiver 5300. The inductive transmitter 5200 includes a primary inductor 5220 and a driving unit 5230. The inductive receiver 5300 includes a secondary inductor 5320, a rectifier 5330 and a receiver-side regulator 5350.

The receiver side regulator 5350 includes a comparitator 5352, a switching unit 5354 and a capacitor 5356. The comparitator 5352 is configured to compare the output signal Vout from the rectifier 5330 with a reference value. The switching unit 5354 consists of a pair of power MOSFETs M5, M6 connected source to source so as to serve as an AC switch. The output of the comparitator 5352 is converted into a digital signal which is communicated to the gate signal of the power MOSFETs to control the switching unit 5354. The capacitor 5356 is selectively connected in parallel with the secondary inductor 5320 to raise the natural resonant frequency of the system to raise the output voltage as described above.

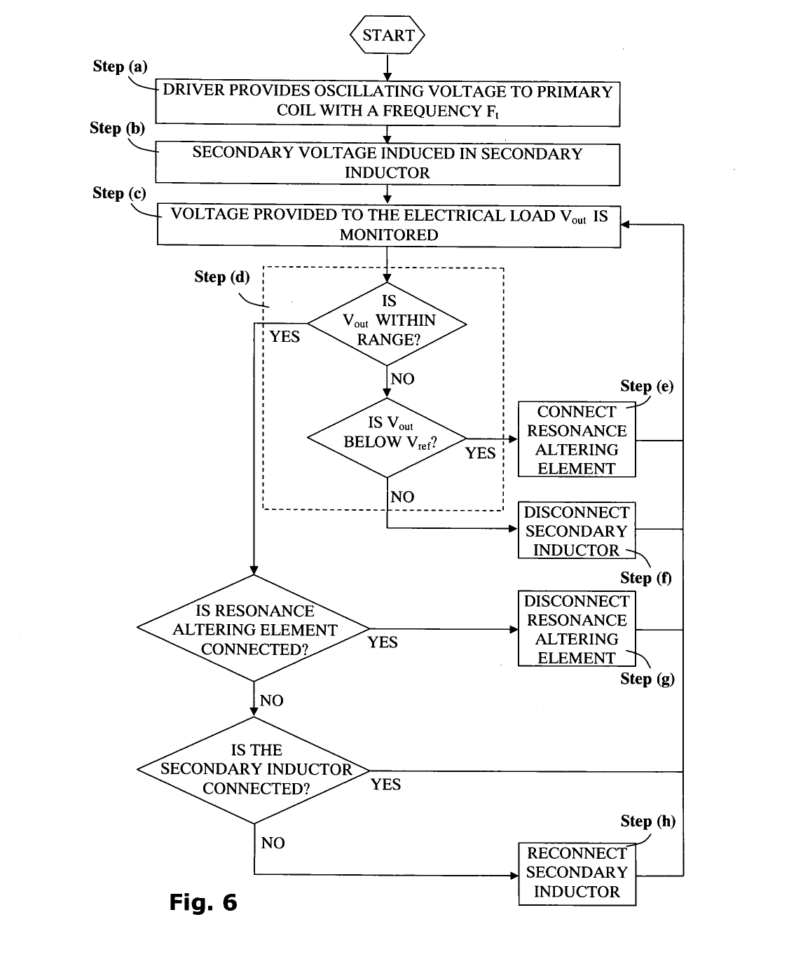

Power regulation may be controlled according to a method represented by the flowchart shown in FIG. 6. The method includes the steps: step (a)—driving a primary inductor at a transmission frequency significantly different from a first resonant frequency of the inductive power transfer system, step (b)—inducing a secondary voltage across a secondary inductor associated with the reception circuit, step (c)—monitoring the output voltage from the reception circuit, step (d)—comparing the output voltage with a first reference value, step (e)—if the output voltage drops below the first reference value, connecting a resonance-altering component to the reception circuit such that the resonant frequency of the inductive power transfer system shifts closer to the transmission frequency, step (f)—if the output voltage rises above a second reference value, disconnecting the secondary inductor from the reception circuit, step (g)—disconnecting the resonance-altering component from the reception circuit when the output voltage reaches the first reference value and step (h)—reconnecting the secondary inductor from the reception circuit when the output voltage reaches the second reference value.

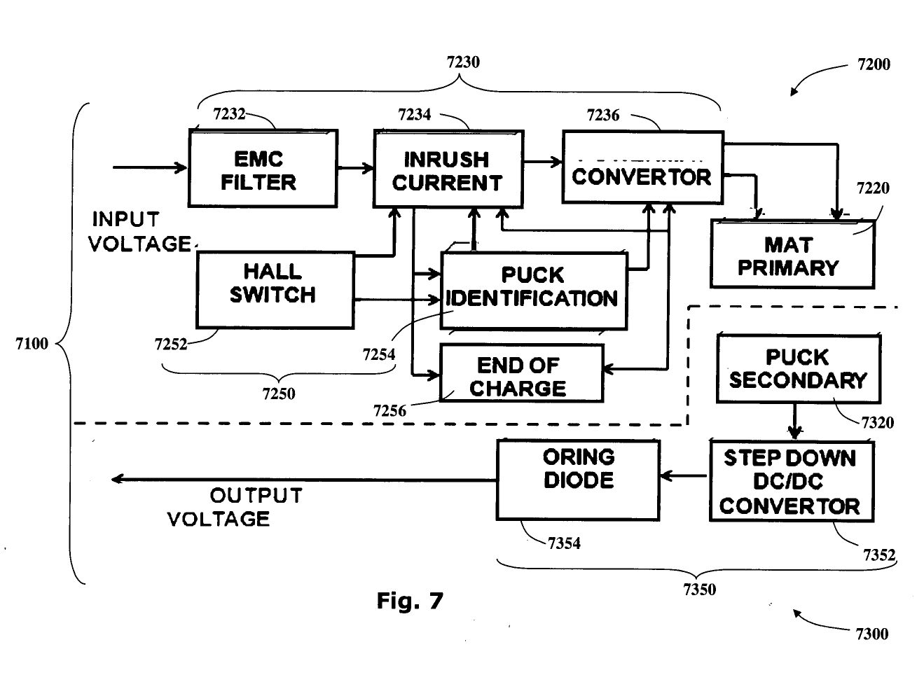

Referring now to the block diagram FIG. 7 the main electrical components of a constant frequency inductive power transmission system 7100 are shown including a receiver-side regulator 7350. The inductive power transmission system 7100 which includes an inductive power transmitter 7200 and an inductive power receiver 7300 is configured to operate at a constant frequency. The operating frequency may be selected to be at the natural frequency of the receiver unit 7300.

The inductive power receiver 7300 includes a secondary inductor 7320, a step down DC/DC converter 7532 and an O-ring diode 7354. The secondary inductor 7320 is connected to a step down DC/DC converter 7352 configured to maintain a constant voltage output which is further stabilized by the O-ring diode 7354.

The inductive power transmitter 7200 includes a primary inductor 7220, a driver unit 7230 and an activation unit 7250. The activation unit 7250 comprises a Hall switch 7252, a puck (receiver) identification unit 7254 and an end of charge controller 7256. The Hall switch 7252 is configured to detect the presence of a magnetic element associated with the receiving unit 7300 and to send a signal to the puck identification unit 7254 which then sends an activation signal to the driver unit 7230. The end of charge controller 7256 is configured to deactivate the driving unit 7230 when no further power is required by the receiving unit. Although separate units are indicated for each of these elements, where appropriate a single microcontroller may be provided having multiple functionality. For example a single microcontroller may provide puck identification and end of charge control functionality as well as a pulse signal to the driver at the operating frequency.

The driver unit 7230 includes an EMC filter 7232, an inrush current unit 7234 and a converter 7236. It is a particular feature of the driver unit that the activation signal from the puck identification unit 7254 may trigger the inrush current unit 7234 to initiate a soft start gradually increasing the voltage to the primary inductor 7220, possibly linearly, from zero until it reaches the input voltage.

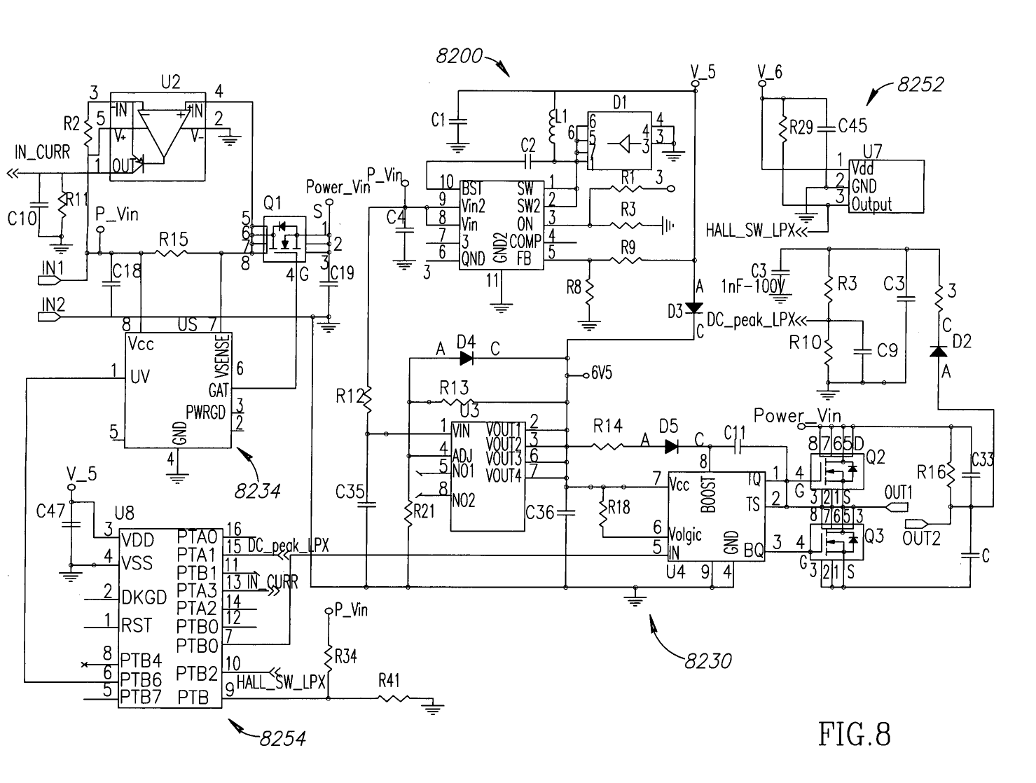

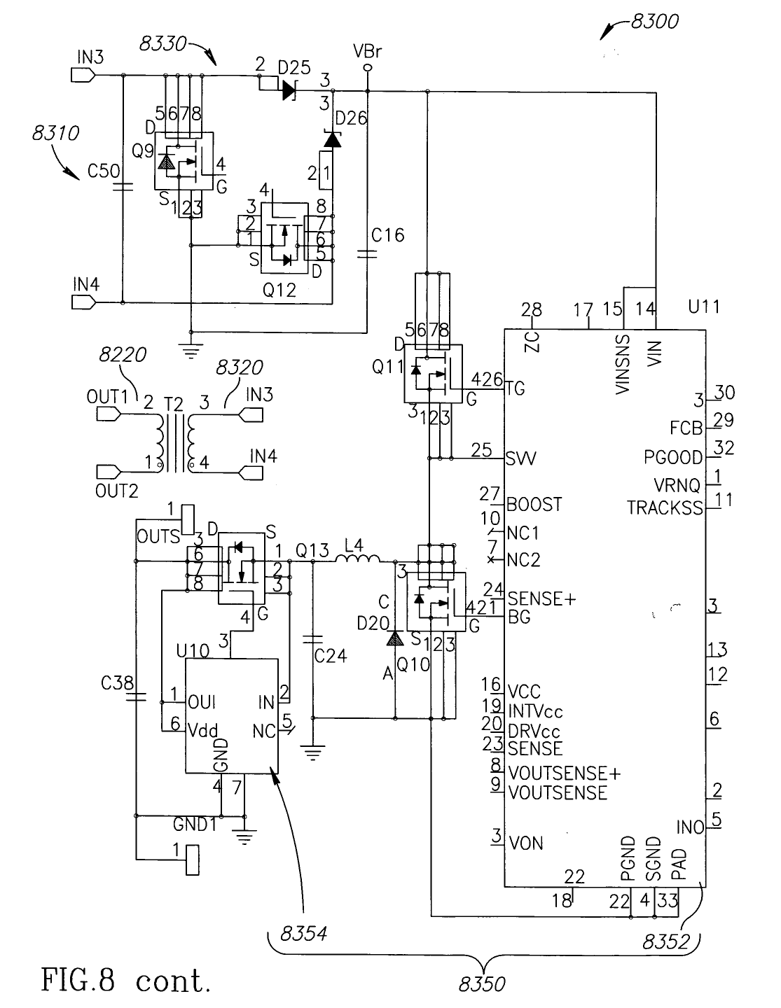

Reference is now made to FIG. 8 showing a possible circuit diagram of a further basic inductive power transfer system. The inductive power transfer system 8100 includes an inductive transmitter 8200 and an inductive receiver 8300. The inductive transmitter 8200 includes a primary inductor 8220 an inrush current unit 8234 and a driving unit 8230. The inductive receiver 8300 includes a secondary inductor 8320, a capacitance element 8310, a rectifier 8330 and a receiver-side regulator 8350. The receiver side regulator 8350 includes a step-down DC/DC converter 8532 unit and an O-ring diode unit 8354.

The capacitance element 8310 is connected in parallel to the secondary inductor 8320 and is configured to produce a half-sinewave shape to the primary current flowing through the primary inductor 8220. It is particularly noted that the half-sinewave shape of the primary inductor 8220 has a smooth profile with no sudden switching. Therefore, less electromagnetic interference (EMI) is generated which is typically associated with stepped signal profiles. Consequently, the inductive transfer system 8100 as a whole is more efficient than systems having stepped profiles. Furthermore, it is noted that the number of turns of the windings of the primary inductor 8220 and secondary inductor 8320 may be thereby reduced.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1-18. (canceled)

19. A method for regulating output voltage from a reception circuit of an inductive power transfer system, the method comprising the steps:
step (a)—driving a primary inductor at a transmission frequency different from a first resonant frequency of the inductive power transfer system;
step (b)—inducing a secondary voltage across a secondary inductor associated with the reception circuit;
step (c)—monitoring the output voltage from the reception circuit;
step (d)—comparing the output voltage with a first reference value; and
step (e)—if the output voltage is less than the first reference value, connecting a resonance-altering component to the reception circuit such that the resonant frequency of the inductive power transfer system shifts closer to the transmission frequency.

20. The method of claim 19 further comprising the additional step of:
step (f)—if the output voltage is above a second reference value, disconnecting the secondary inductor from the reception circuit.

21. The method of claim 20 further comprising the additional step of:
step (g)—disconnecting the resonance-altering component from the reception circuit when the output voltage equals the first reference value.

22. The method of claim 21 further comprising the additional step of:
step (h)—reconnecting the secondary inductor from the reception circuit when the output voltage equals the second reference value.

23-27. (canceled)

28. An inductive power receiver having a reception circuit configured to inductively couple with an inductive power transmitter to form an inductive transfer system characterized by a first resonance frequency, the reception circuit comprising:
(a) at least one secondary inductor configured to inductively couple with a primary inductor associated with the inductive power transmitter; and
(b) a regulator, configured to regulate an output voltage of the reception circuit, wherein the regulator comprises:
(i) a comparator configured to compare the output voltage across with at least one reference value;
(ii) at least one resonance-altering component; and
(iii) at least one switching unit connected to the comparator and configured to selectively connect the resonance-altering component to the reception circuit based on a comparison between the output voltage and a first reference value;
wherein the inductive power transmitter is configured to generate a driving voltage across the primary inductor at a transmission frequency that is significantly different from the first resonant frequency.

29. The inductive power receiver of claim 28 wherein the resonance-altering component is configured such that, when the resonance-altering component is connected to the reception circuit, the inductive transfer system has a second resonant frequency that is closer to the transmission frequency than the first resonant frequency; and
wherein the switching unit is configured to connect the resonance-altering component to the receiver circuit when the output voltage is less than the first reference value, as determined by the comparator, and to disconnect the resonance-altering component from the receiver circuit when the output voltage is above the first reference value, as determined by the comparator.

30. The inductive power receiver of claim 29 wherein the regulator is further configured to disconnect the secondary inductor from the receiver circuit when the output voltage is higher than a second reference value, as determined by the comparator, and to connect the secondary inductor to the receiver circuit when the output voltage is lower than the second reference value, as determined by the comparator, and
wherein the second reference value is higher than the first reference value.

31. The inductive power receiver of claim 28 wherein the transmission frequency is higher than the first resonant frequency and the resonance-altering component is selected such that the second resonant frequency is higher than the first resonant frequency.

32. The inductive power receiver of any one of claim 28 wherein the transmission frequency is lower than the first resonant frequency and the resonance-altering component is selected such that the first resonant frequency is higher than the second resonant frequency.

33. The inductive power receiver of claim 28 wherein the resonance-altering component comprises at least one item selected from the group consisting of a capacitor and an inductor.

34. The inductive power receiver of claim 28 wherein the resonance-altering component comprises a capacitor selectively connectable in parallel to the secondary inductor.

35. The inductive power receiver of claim 28 wherein the regulator further comprises one or more items selected from the group consisting of: the switching unit comprising at least one power MOSFET, at least one step-down DC/DC converter and at least one O-ring diode.

36. The inductive power receiver of claim 28, wherein the reception circuit further comprises a capacitance element connected across the terminals of the secondary inductor such that a current through the primary inductor has a smooth half-sinewave profile.

37. An electrical device incorporating the inductive power receiver of claim 28.

38. The electrical device of claim 37 being selected from a group consisting of: telephones, media players, PDAs, Walkman®s, portable music players, dictaphones, portable DVD players, mobile communications devices, standing lamps, video recorders, DVD players, paper shredders, fans, photocopiers, computers, printers, cooking appliances, fridges, freezers, washing machines, clothes dryers, heavy machinery, desk lamps, ambient lighting units, fans, wireless telephones, speakers, speaker phones, conference call base units, electric pencil sharpeners, electric staplers, display devices, electronic picture frames, VDUs, projectors, televisions, video players, music centers, calculators, scanners, fax machines, hot plates, electrically heated mugs, mobile phones, hairdryers, shavers, exfoliators, delapidators, heaters, wax-melting equipment, hair curlers, beard trimmers, bathroom-scales, lights and radios, egg beaters, bread-makers, liquidizers, citrus juice extractors, vegetable juicers, food-processors, electric knives, toasters, sandwich toasters, waffle makers, electrical barbecue grills, slow cookers, hot-plates, deep-fat fryers, electrical frying pans, knife sharpeners, domestic sterilizers, kettles, urns, radios, cassette players, CD players and electrical can-openers, popcorn makers and magnetic stirrers.
